(19) United States
(12) Patent Application Publication
(10) Pub. No.: US 2012/0300467 A1
(43) Pub. Date: Nov. 29, 2012

(54) OPTICAL LENS AND LIGHTING DEVICE

(75) Inventor: TIEN-PAO CHEN, NEW TAIPEI CITY (TW)

(73) Assignee: ASIA VITAL COMPONENTS CO., LTD., KAOHSIUNG CITY (TW)

(21) Appl. No.: 13/448,489

(22) Filed: Apr. 17, 2012

(30) Foreign Application Priority Data
May 26, 2011 (TW) 100118435

(51) Int. Cl. F21V 5/04

(52) U.S. Cl. 362/311.01; 362/335

(57) ABSTRACT

A lighting device includes a light source and an optical lens. The optical lens includes a light-source-side optical surface disposed proximate to the light source, and a lighting-side optical surface opposite to the light-source-side optical surface. At least one of the light-source-side optical surface and the lighting-side optical surface satisfies a bi-axial sag function.

### CROSS-REFERENCE TO RELATED APPLICATION

This application claims priority to Taiwanese Application No. 100118435, filed on May 26, 2011.

### BACKGROUND OF THE INVENTION

1. Field of the Invention

The invention relates to a lighting device, and more particularly to a lighting device for forming a bi-axial light pattern.

2. Description of the Related Art

For light emitting diode (LED) package devices, a light pattern thereof is generally circular, and a luminous intensity thereof has a Lambertian distribution, as shown in FIG. 1. That is, the farther away from the optical axis, the sharper will be the drop in illuminance. In many lighting applications, people desire the light patterns of lighting equipments to vary with different applications and the illuminance distribution to be as uniform as possible. Therefore, in recent years, manufacturers have developed various LED lighting devices by adding a lens on the LED light path to change the light pattern or the luminous intensity distribution so as to meet various demands.

Besides, when the LED is applied to road lighting, there are four main kinds of arrangements for LED street lights: single side arrangement suitable for narrow lanes; opposite side arrangement suitable for wide lanes; staggered arrangement; and central separator strip arrangement suitable for roads with sufficiently wide central separator strips. Except for the central separator strip arrangement, the back side of street light poles in the other three arrangements is usually a sidewalk (about two meters wide). However, the width of the sidewalk is usually much smaller than the width (at least seven meters wide) of a road. Therefore, it is necessary to tilt the street light poles to a specific angle (generally 0˜15 degrees) so as to increase the ratio of light projected onto the road.

Such a scheme is only suitable when the road is not too wide. When the road is wider, a further increase in the tilt angle of the street light poles is needed for the sidewalk and the vehicle lane to have sufficient illuminance at the same time. However, the tilt angle of the street light poles cannot be increased unlimitedly based on legal and safety considerations.

### SUMMARY OF THE INVENTION

Therefore, an object of the present invention is to provide an optical lens having at least one optical surface that satisfies a bi-axial sag function such that a light pattern to be formed using the optical lens has bi-axial characteristics.

According to the present invention, an optical lens is adapted for use with a light source and comprises a light-source-side optical surface to be disposed proximate to the light source, and a lighting-side optical surface opposite to the light-source-side optical surface. At least one of the light-source-side optical surface and the lighting-side optical surface satisfies a bi-axial sag function.

Another object of the present invention is to provide a lighting device that includes the optical lens.

According to another aspect of the present invention, a lighting device comprises alight source and an optical lens. The optical lens includes a light-source-side optical surface disposed proximate to the light source, and a lighting-side optical surface opposite to the light-source-side optical surface. At least one of the light-source-side optical surface and the lighting-side optical surface satisfies a bi-axial sag function.

### BRIEF DESCRIPTION OF THE DRAWINGS

Other features and advantages of the present invention will become apparent in the following detailed description of the preferred embodiments with reference to the accompanying drawings, of which:

FIG. 1 is a plot showing the luminous intensity distribution of a light emitting diode package device;

FIG. 2 is a perspective view showing the first preferred embodiment of a lighting device according to the present invention, an optical lens of which is designed using a first set of parameters;

FIG. 3 is a schematic view of FIG. 2, in which solid lines represent profile in an X-axis direction, and broken lines represent profile in a Y-axis direction;

FIG. 4 is a plot showing the luminous intensity distributions of light passing through the optical lens of the embodiment of FIG. 2;

FIG. 5 shows the illuminance distribution and light pattern measured for light passing through the optical lens of the embodiment of FIG. 2 at a distance of 8 meters from the optical lens;

FIG. 6 is a perspective view showing the first preferred embodiment of the lighting device according to the present invention, the optical lens of which is designed using a second set of parameters;

FIG. 7 is a schematic view of FIG. 6, in which solid lines represent the profile in the X-axis direction, and broken lines represent the profile in the Y-axis direction;

FIG. 8 is a plot showing the luminous intensity distributions of light passing through the optical lens of the embodiment of FIG. 6;

FIG. 9 shows the illuminance distribution and light pattern measured for light passing through the optical lens of the embodiment of FIG. 6 at a distance of 8 meters from the optical lens;

FIG. 10 is a perspective view showing the first preferred embodiment of the lighting device according to the present invention, the optical lens of which is designed using a third set of parameters;

FIG. 11 is a schematic view of FIG. 10, in which solid lines represent the profile in the X-axis or Y-axis direction, and broken lines represent the profile in the X=Y direction;

FIG. 12 is a plot showing the luminous intensity distributions of light passing through the optical lens of the embodiment of FIG. 10;

FIG. 13 shows the illuminance distribution and light pattern measured for light passing through the optical lens of the embodiment of FIG. 10 at a distance of 8 meters from the optical lens;

FIG. 14 is a schematic view to illustrate profile in the X-axis direction of the second preferred embodiment of the lighting device according to the present invention;

FIG. 15 is a schematic view to illustrate profile in the Y-axis direction of the second preferred embodiment;

FIG. 16 is a plot showing the luminous intensity distributions of light passing through the optical lens of the second preferred embodiment;

FIG. 17 shows the illuminance distribution measured at a vehicle lane for light passing through the optical lens when the second preferred embodiment is applied to a light pole tilted by 15 degrees; and

FIG. 18 shows the illuminance distribution measured at a sidewalk for light passing through the optical lens when the second preferred embodiment is applied to a light pole tilted by 15 degrees.

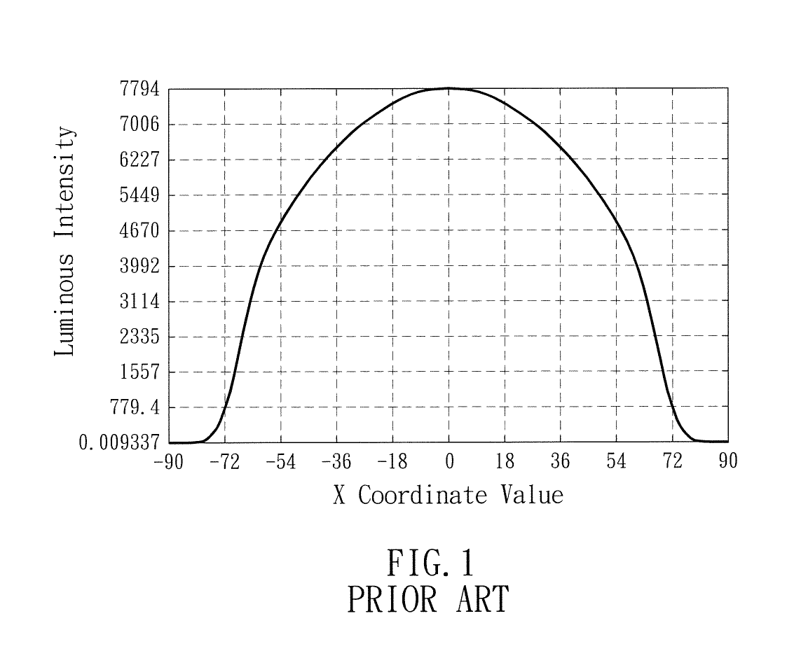

### DETAILED DESCRIPTION OF THE PREFERRED EMBODIMENTS

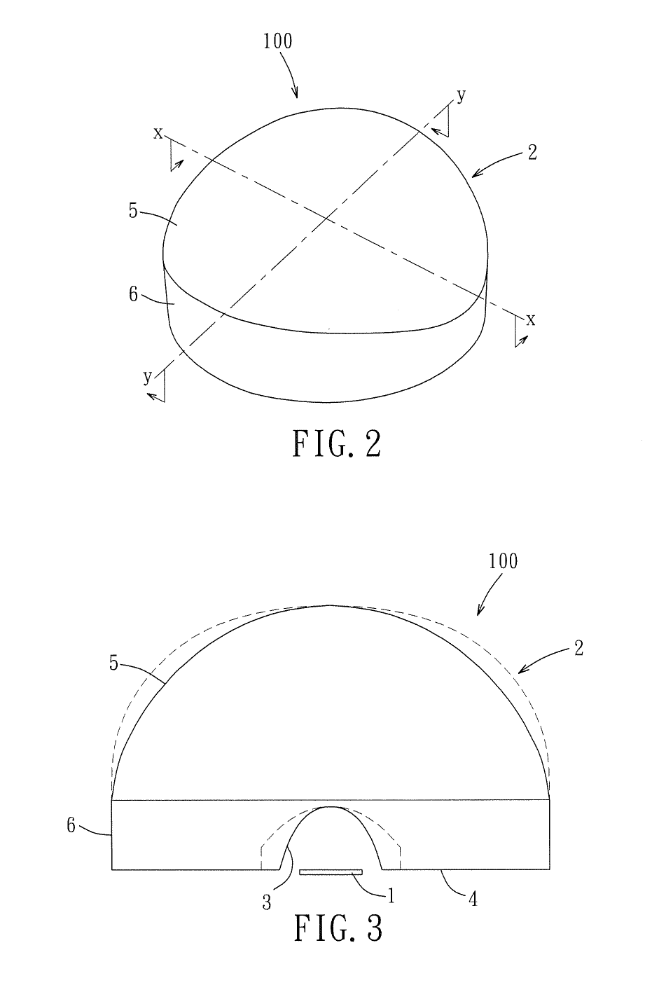

Referring to FIG. 2 and FIG. 3, a preferred embodiment of the lighting device 100 of the present invention is shown to include a light source 1 and an optical lens 2. The optical lens 2 includes a light-source-side optical surface 3 disposed proximate to the light source 1, an extension surface 4 extending outwardly from a periphery of the light-source-side optical surface 3, a lighting-side optical surface 5 opposite to the light-source-side optical surface 3, and a surrounding surface 6 interconnecting the extension surface 4 and the lighting-side optical surface 5. Area of a projection of the light-source-side optical surface 3 onto a reference plane is smaller than area of a projection of the lighting-side optical surface 5 onto the reference plane.

In this embodiment, the light-source-side optical surface 3 satisfies a first bi-axial sag function:

$$z = \frac{{cr}^{2}}{1 + \sqrt{1 - ( 1 + k ) {c}^{2} {r}^{2}}} + {\sum }_{i = 1}^{N} ( {A}_{i} {x}^{2 i} + {B}_{i} {y}^{2 i} ) \qquad [ Function 1 ]$$

in which, z is amount of sag at an arbitrary point on the optical surface, r is a polar coordinate of the arbitrary point, x and y are right angle coordinates of the arbitrary point in a right angle coordinate system, c is a curvature parameter, k is a conic constant, Aᵢ and Bᵢ are constants, and N is a predetermined number.

In this embodiment, the lighting-side optical surface 5 satisfies a second bi-axial sag function similar to Function 1. The only difference between the second bi-axial sag function and the first bi-axial sag function resides in the values of the parameters c, k, Aᵢ and Bᵢ.

Alight pattern formed as a result of light from the light source 1 passing through the optical lens 2 has a full width at half maximum (FWHM) θ₁ along a first axis larger than a FWHM θ₂ along a second axis that is transverse to the first axis. Values of c and k define a basic circular light pattern with a FWHM smaller than θ₁. Final values of θ₁ and θ₂ are determined based on values of Aᵢ and Bᵢ and the basic circular light pattern defined by the values of c and k.

Three sets of different parameters are exemplified below to illustrate the lighting device of this embodiment, wherein N is equal to two but is not limited thereto.

| | | c | k | A₁ | A₂ | B₁ | B₂ |
|---|---|---|---|---|---|---|---|
| Ex. 1 | Light- | −0.1374 | 10 | −0.3849 | −0.1607 | −0.1999 | 0.0008 |
| | source-side | | | | | | |
| | optical | | | | | | |
| | surface | | | | | | |
| | Lighting- | −0.1102 | 1.0982 | −0.0300 | −0.0001 | 0.0135 | −0.0006 |
| | side optical | | | | | | |
| | surface | | | | | | |

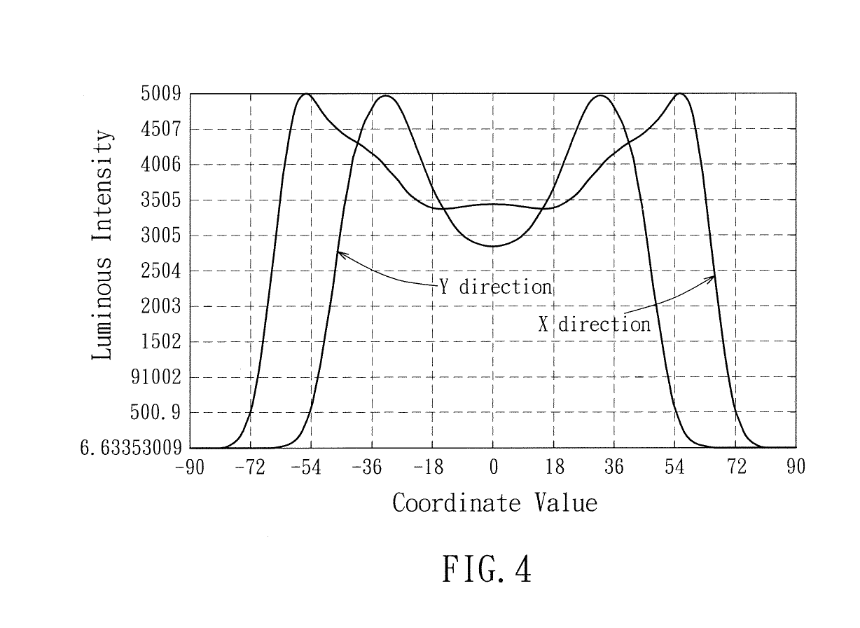

Among the parameters in Example 1, Aᵢ is different from Bᵢ. As shown in FIG. 3, the optical lens 2 has different curved profiles in the X-axis and Y-axis directions. Therefore, light will have different degrees of refractions along the X-axis and Y-axis directions after passing through the optical lens 2, thereby transforming the luminous intensity distribution from the original Lambertian distribution of the light source 1 to the luminous intensity distributions shown in FIG. 4.

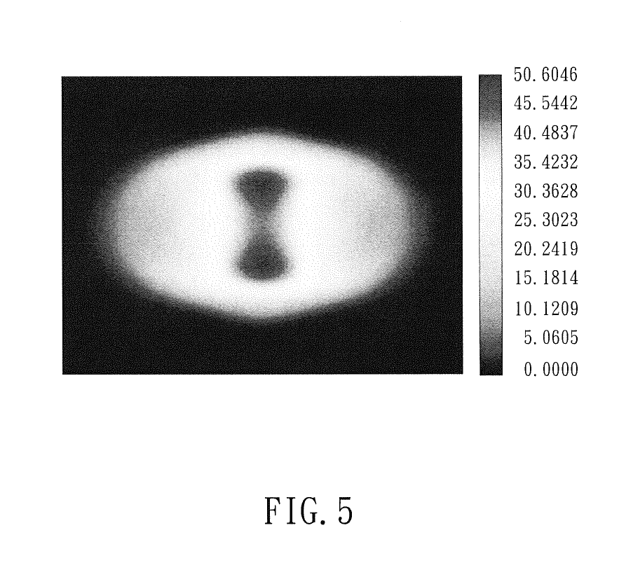

It is noted that the Lambertian distribution has a maximum luminous intensity at an angle of zero degree, and the luminous intensity distribution decreases according to a cosine formula. In terms of illuminance, the highest illuminance is at the optical axis, and illuminance decreases rapidly with an increase in angle. Therefore, illuminance becomes weaker with the farther distance from the optical axis. On the other hand, the optical lens 2 of this embodiment can change the original luminous intensity distribution of the light source 1, so that the maximum luminous intensity is located apart from the optical axis (as shown in FIG. 4), and so that illuminance at an off-axis location can be effectively enhanced (as shown in FIG. 5).

Regarding light pattern adjustment, since the amounts of sag in the X-axis direction and the amounts of sag in the Y-axis direction are different, the light pattern formed by the light passing through the optical lens 2 has different levels of expansion or contraction in the X-axis and Y-axis directions, thus achieving the effect of light pattern adjustment.

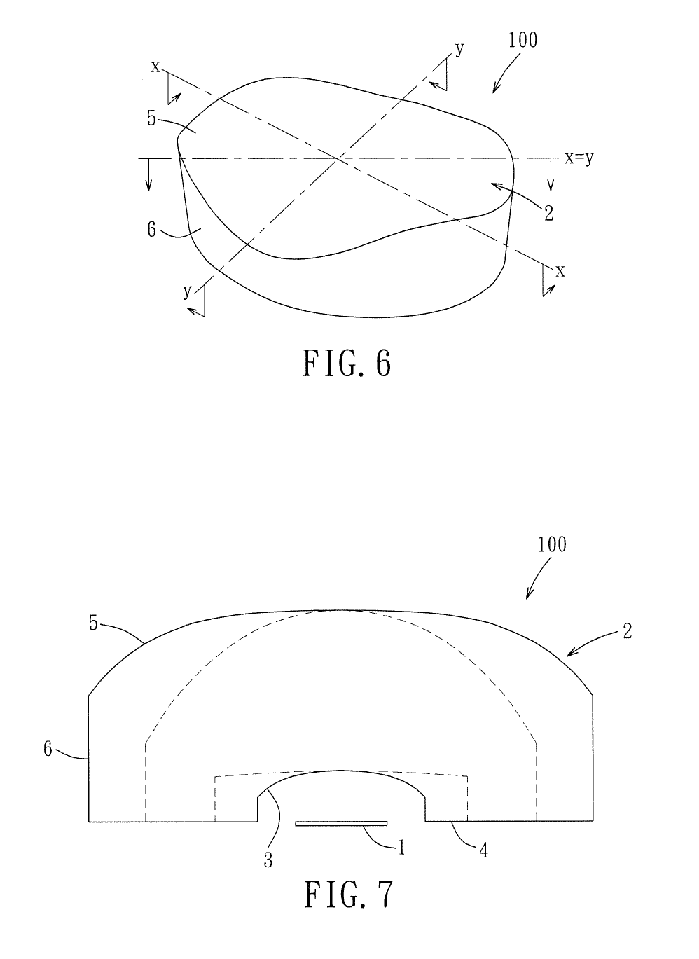

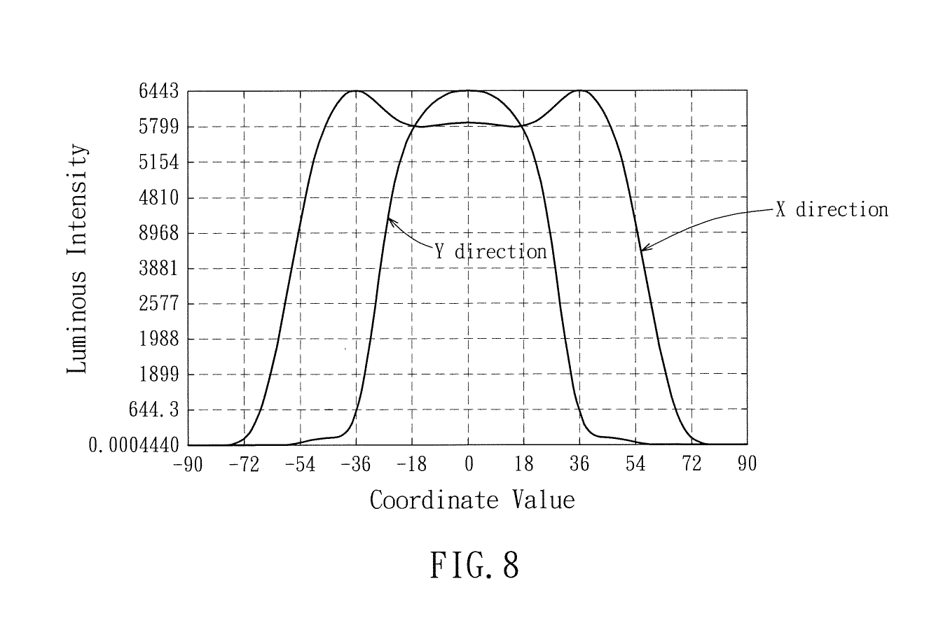

Adjustment of the luminous intensity distribution of the light passing through the optical lens 2 can be made by further adjusting each of the parameters. In the following example shown in FIG. 6 to FIG. 9, a second set of parameters is used.

| | | c | k | A₁ | A₂ | B₁ | B₂ |
|---|---|---|---|---|---|---|---|
| Ex. 2 | Light- | −0.11110 | 1.2787 | 0.0136 | −0.0064 | 0.0426 | 0.0007 |
| | source-side | | | | | | |
| | optical | | | | | | |
| | surface | | | | | | |
| | Lighting- | −0.3161 | −1.0801 | 0.1501 | −0.0006 | 0.0843 | −0.0008 |
| | side optical | | | | | | |
| | surface | | | | | | |

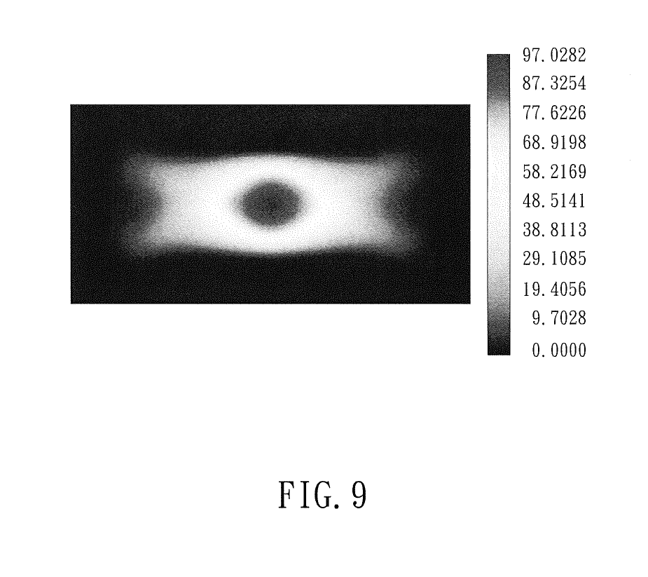

The principles are the same as those in Example 1. Through the design of the parameters, greater differences in refraction levels are formed between the X-axis and Y-axis directions, and the light pattern is transformed to a generally rectangular shape (as shown in FIG. 9), and has better uniformity compared to the light pattern formed without using the optical lens 2.

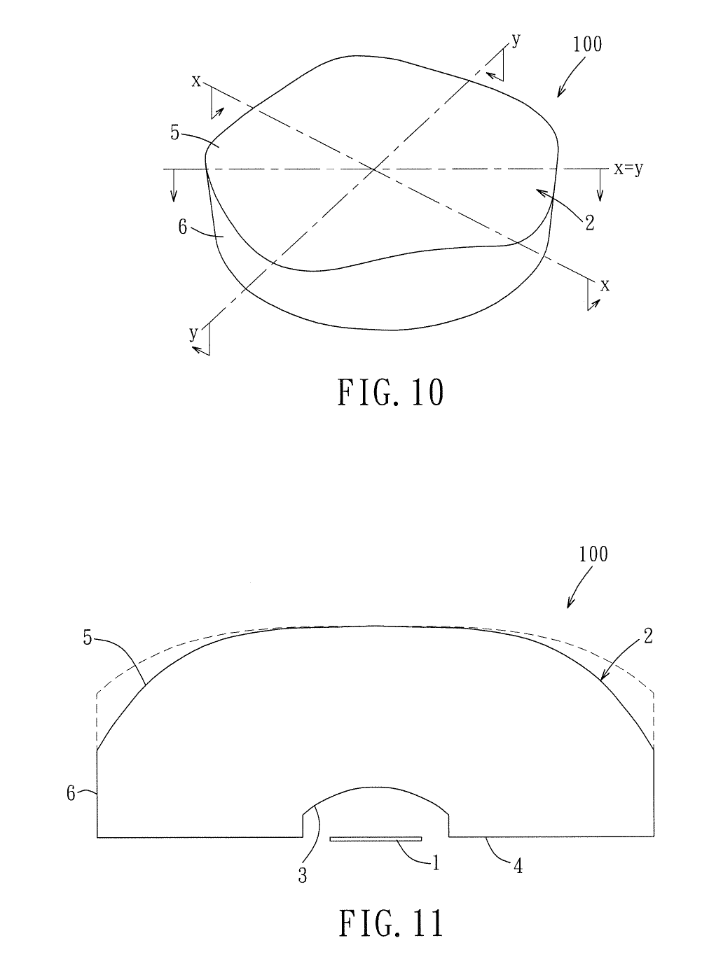

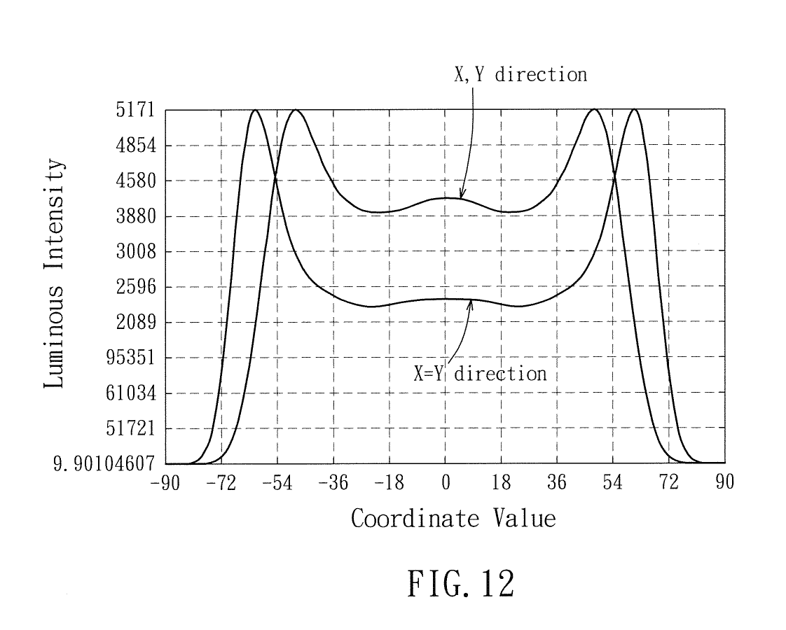

In the following example shown in FIGS. 10 to 13, a third set of parameters is used.

| | | c | k | A₁ | A₂ | B₁ | B₂ |
|---|---|---|---|---|---|---|---|
| Ex. 3 | Light- | −0.1327 | 4.2217 | −0.0729 | 0.0017 | =A₁ | =A₂ |
| | source-side | | | | | | |
| | optical | | | | | | |
| | surface | | | | | | |
| | Lighting- | −0.1019 | −0.9502 | 0.0478 | −0.0004 | =A₁ | =A₂ |
| | side optical | | | | | | |
| | surface | | | | | | |

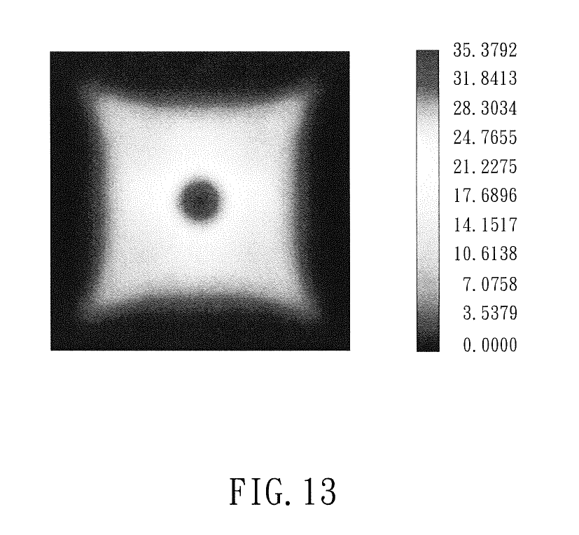

In Example 3, Aᵢ equals Bᵢ, and the function is symmetrical along the x=y plane or x=−y plane. Therefore, while the profile along the X-axis is the same as the profile along the Y-axis, the profile differs from those along other axes. The light pattern is generally formed into a square (as shown in FIG. 13) and has better uniformity compared to the light pattern formed without using the optical lens 2.

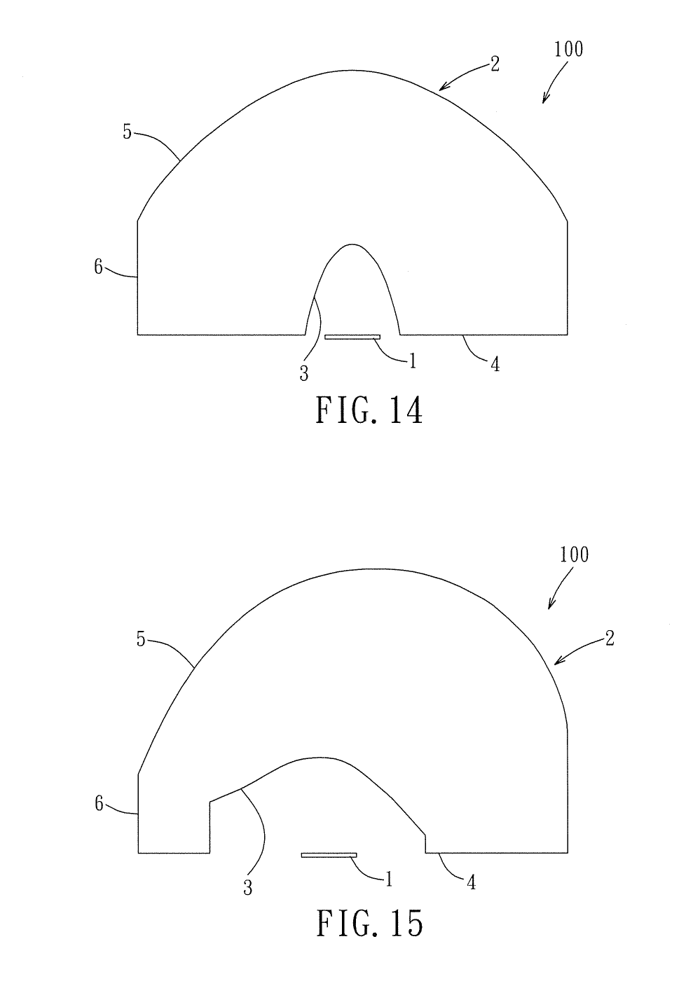

Referring to FIG. 14 to FIG. 16, at least one of the light-source-side optical surface 3 and the lighting-side optical surface 5 of the optical lens 2 in the second preferred embodiment of the lighting device according to the present invention satisfies the following bi-axial sag function:

$$z = \frac{{cr}^{2}}{1 + \sqrt{1 - ( 1 + k ) {c}^{2} {r}^{2}}} + {\sum }_{i = 1}^{N} {A}_{i} {x}^{2 i} + {\sum }_{j = 1}^{M} {B}_{j} {y}^{j} \qquad [ Function 2 ]$$

in which, z is amount of sag at an arbitrary point on the optical surface, r is a polar coordinate of the arbitrary point, x and y are right angle coordinates of the arbitrary point in a right angle coordinate system, c is a curvature parameter, k is a conic constant, Aᵢ and Bⱼ are constants, and N and M are predetermined numbers.

In this embodiment, one of the light-source-side optical surface 3 and the lighting-side optical surface 5 satisfies Function 2 and the other one of the optical surfaces 3, 5 is a planar surface or satisfies Function 1, or both optical surfaces 3, 5 may satisfy Function 2.

The following set of parameters is used to illustrate a non-limiting example of the second preferred embodiment, wherein N equals two and M equals five.

| | c | k | A₁ | A₂ | B₁ | B₂ | B₃ | B₄ | B₅ |
|---|---|---|---|---|---|---|---|---|---|
| Light- | −0.1545 | 0.4788 | −0.6040 | −0.0462 | −0.1810 | −0.0027 | 0.0048 | −3.1185e−006 | −0.1281 |
| source-side | | | | | | | | | |
| optical | | | | | | | | | |
| surface | | | | | | | | | |
| Lighting- | −0.0903 | 0.2180 | −0.0317 | 0.0003 | 0.2277 | 0.0019 | −0.0002 | 9.1881e−006 | −0.0169 |
| side optical | | | | | | | | | |
| surface | | | | | | | | | |

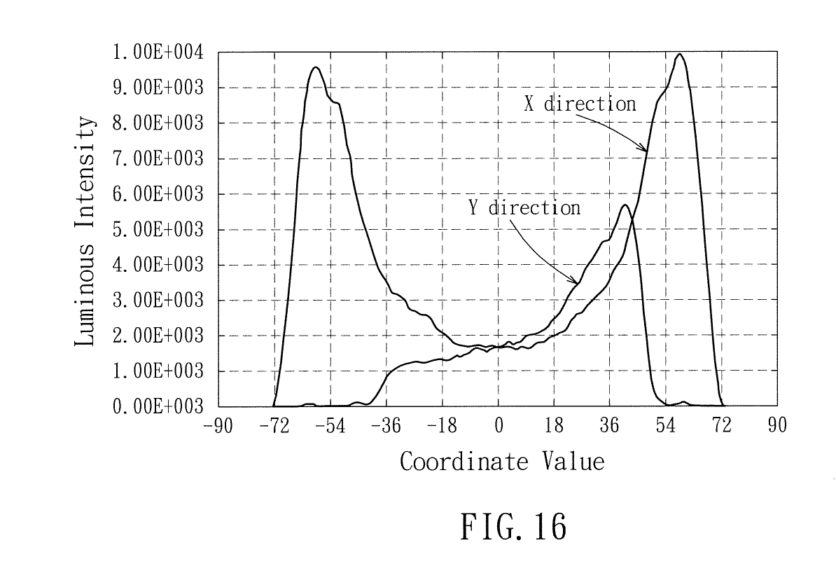

The sag function of this embodiment is a function that is symmetrical along the Y-axis and asymmetrical along the X-axis. Accordingly, the optical surface is also symmetrical along the Y-axis and as symmetrical along the X-axis, as shown in FIG. 14 and FIG. 15. By virtue of the asymmetry of the curvature of the optical lens 2 along the +y direction and −y direction, more light may be emitted in the +y direction, and the luminous intensity distributions are as shown in FIG. 16.

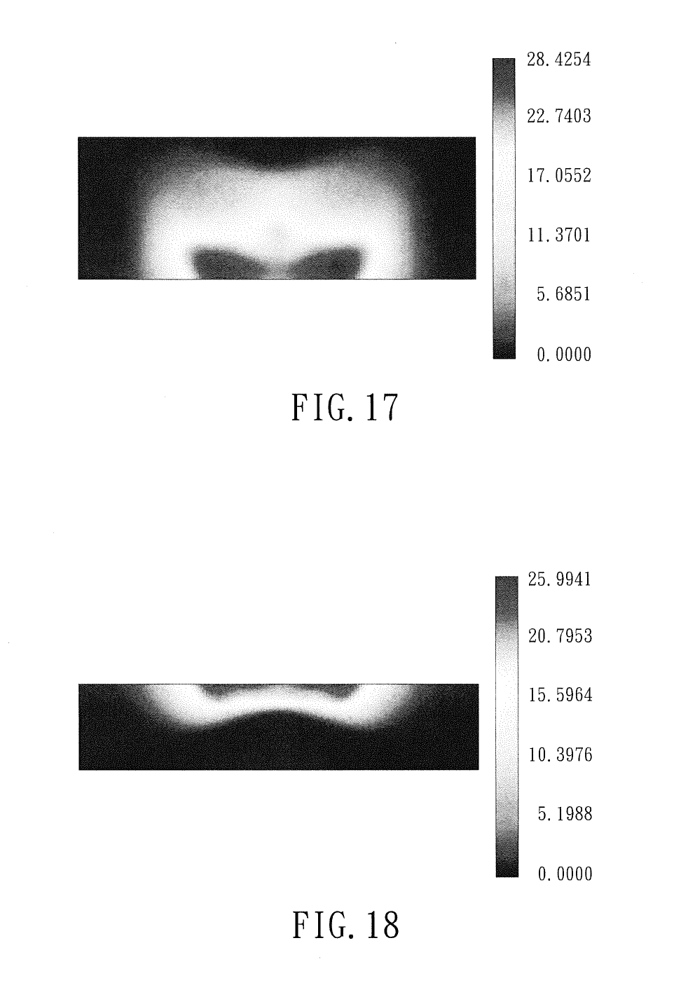

Taking an LED street light as an actual application for example, under the condition of the light height being eight meters and the light pole being tilted by 15 degrees, the lighting range is as shown in FIG. 17 and FIG. 18, in which the length along the road is 32 meters, the width on the vehicle lane is 14.8 meters (67.2% of the light energy), and the width on the sidewalk is 3.6 meters (20.1% of the light energy). Performance was found to better than that of the symmetrical type of design.

Besides, using the sequential arrangement of lights on a road as basis for comparison, if the road has six vehicle lanes, a width of 25 meters, and light poles tilted by 15 degrees, and is analyzed with the distance between lights in opposite side arrangement being 32 meters, this embodiment can achieve an average illuminance of 25 lumens and uniformity (min/ave) of 60.1%. Such results are better than the performance of the symmetrical type of design with the average illuminance of 22 lumens and uniformity (min/ave) of 33.6%.

To sum up, the present invention uses bi-axial sag functions to design curved surfaces of the optical lens 2. The profile along the X-axis direction and the profile along the Y-axis direction of the optical lens present different curves, so that the light passing through the optical lens 2 has different levels of refractions in the X-axis and Y-axis directions, and the luminous intensity distribution of the emitted light from the light source 1 is transformed from the original Lambertian distribution so that the maximum luminous intensity is located relatively far from the optical axis, thus effectively enhancing illuminance at the off-axis location. Through adjusting the parameters in one direction, a single-axis asymmetric curved surface may be designed to meet asymmetric lighting demands.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An optical lens adapted for use with a light source, said optical lens comprising a light-source-side optical surface to be disposed proximate to the light source, and a lighting-side optical surface opposite to said light-source-side optical surface;
wherein at least one of said light-source-side optical surface and said lighting-side optical surface satisfies a bi-axial sag function.

2. The optical lens as claimed in claim 1, wherein the bi-axial sag function is:
$$z = \frac{{cr}^{2}}{1 + \sqrt{1 - ( 1 + k ) {c}^{2} {r}^{2}}} + {\sum }_{i = 1}^{N} ( {A}_{i} {x}^{2 i} + {B}_{i} {y}^{2 i} )$$
in which, z is amount of sag at an arbitrary point on said optical surface, r is a polar coordinate of the arbitrary point, x and y are right angle coordinates of the arbitrary point in a right angle coordinate system, c is a curvature parameter, k is a conic constant, Aᵢ and Bᵢ are constants, and N is a predetermined number.

3. The optical lens as claimed in claim 2, wherein both of said light-source-side optical surface and said lighting-side optical surface satisfy the bi-axial sag function, alight pattern formed from light that passes through said optical lens being symmetrical along an X-axis and along a Y-axis.

4. The optical lens as claimed in claim 3, wherein Aᵢ and Bᵢ are different, and for each of said light-source-side optical surface and said lighting-side optical surface, the amounts of sag in an X-axis direction of the right angle coordinate system are different from the amounts of sag in a Y-axis direction of the right angle coordinate system.

5. The optical lens as claimed in claim 3, wherein N is equal to 2.

6. The optical lens as claimed in claim 2, wherein N is equal to 2.

7. The optical lens as claimed in claim 2, wherein a light pattern formed from light passing through said optical lens has a full width at half maximum (FWHM) θ₁ along a first axis larger than a FWHM θ₂ along a second axis that is transverse to the first axis, values of c and k defining a basic circular light pattern with a FWHM smaller than θ₁, final values of θ₁ and θ₂ being determined based on values of Aᵢ and Bᵢ and the basic circular light pattern defined by the values of c and k.

8. The optical lens as claimed in claim 1, wherein the bi-axial sag function is:
$$z = \frac{{cr}^{2}}{1 + \sqrt{1 - ( 1 + k ) {c}^{2} {r}^{2}}} + {\sum }_{i = 1}^{N} {A}_{i} {x}^{2 i} + {\sum }_{j = 1}^{M} {B}_{j} {y}^{j}$$
in which, z is amount of sag at an arbitrary point on said optical surface, r is a polar coordinate of the arbitrary point, x and y are right angle coordinates of the arbitrary point in a right angle coordinate system, c is a curvature parameter, k is a conic constant, Aᵢ and Bⱼ are constants, and N and M are predetermined numbers.

9. The optical lens as claimed in claim 8, wherein a light pattern formed from light that passes through said optical lens is asymmetrical along an X-axis and is symmetrical along a Y-axis.

10. The optical lens as claimed in claim 8, wherein a light pattern formed from light passing through said optical lens has a full width at half maximum (FWHM) θ₁ along a first axis larger than a FWHM θ₂ along a second axis that is transverse to the first axis, values of c and k defining a basic circular light pattern with a FWHM smaller than θ₁, final values of θ₁ and θ₂ being determined based on values of Aᵢ and Bⱼ and the basic circular light pattern defined by the values of c and k.

11. The optical lens as claimed in claim 1, wherein area of a projection of said light-source-side optical surface onto a reference plane is smaller than area of a projection of said lighting-side optical surface onto the reference plane, said optical lens further comprising an extension surface extending outwardly from a periphery of said light-source-side optical surface, and a surrounding surface interconnecting said extension surface and said lighting-side optical surface.

12. A lighting device comprising a light source, and an optical lens including a light-source-side optical surface disposed proximate to said light source, and a lighting-side optical surface opposite to said light-source-side optical surface;
wherein at least one of said light-source-side optical surface and said lighting-side optical surface satisfies a bi-axial sag function.
